(19) United States
(12) Patent Application Publication
(10) Pub. No.: US 2010/0165282 A1
(43) Pub. Date: Jul. 1, 2010

(54) Pillar spacer formation for tenacious LCDs

(75) Inventors: Akihiro Mochizuki, Louisville, CO (US); Atsushi Nakano, Tokyo (JP); Shinichi Kuroda, Zama-shi (JP); Takuya Hirano, Odawara-shi (JP)

Correspondence Address: MORRISON & FOERSTER LLP, 1650 TYSONS BOULEVARD, SUITE 400, MCLEAN, VA, 22102, US

(73) Assignee: Nano Loa, Inc., Kawasaki-shi (JP)

(21) Appl. No.: 12/318,607

(22) Filed: Dec. 31, 2008

(51) Int. Cl. G02F 1/1339

(52) U.S. Cl. 349/155

(57) ABSTRACT

A liquid crystal display panel embedded with pillar type of spacers comprising a photo reactive material, wherein the mechanical durability of the pillar type of spacers has at least 15.9 MPs of mechanical strength to the external pressing force.

### BACKGROUND OF THE INVENTION

1. Field of the Invention

The present invention relates both to a panel design and to a manufacturing method of liquid crystal display devices, particularly for Smectic liquid crystal displays.

2. Related Background Art

Recent increase in application field of liquid crystal displays (LCDs) shows many varieties such as an LCD for smart phones, net personal digital assistance (PDA), computer monitors, and large screen direct view TVs. These emergent increases in application field are based on recent LCDs' improvement in their performance and in their manufacturability. On the other hand, new flat panel display technologies such as Organic Light Emission Displays (OLEDs), Plasma Display Panels (PDPs) have been accelerated in their development and manufacturing to compete with LCDs. Moreover, introduction to new application field of LCDs requests new and higher performance in their image quality to meet with these new application fields. In particular, most of recent emergent application fields require full-color motion video image without any motion image blur, which is still difficult to conventional LCD technology in terms of slow response nature of conventional LCDs. Under the above given circumstances, LCDs are being required higher performance, in particular faster optical response in order to expand their application field competing with new flat panel display technologies which all have faster optical response performance than current LCD technologies. Moreover, effective manufacturing process to meet with higher image quality is also of great concern for volume manufacturing of LCDs. There are several causes for current conventional LCD technologies could not get lid of above poor image quality issues. Slow response time, limited viewing angle and higher manufacturing cost with expensive bill of materials cost are reasons of the issue.

This Invention intends to provide an effective and reasonable solution to get lid of above issues for current LCD technologies are facing.

(General Technical Problems of Current LCD Technologies)

One of the strongest demands to get lid of above poor image quality in conventional LCDs is to have much faster optical response. A much faster optical response provides both intrinsic and additional means to an LCD having much better image quality. Due to slow optical response of conventional LCD technologies, it is extremely difficult to obtain well enough full motion video image quality without showing motion image blur. Moreover, limited viewing angle of conventional LCD technologies require additional or external optical compensation which pushes up manufacturing cost of LCDs.

In order to give an intrinsic solution to above problems, an introduction of faster optical response LCD technology is necessary. Couples of much faster optical response LCD technologies than conventional LCD technologies have been proposed and being developed. However, most of these newer type of LCD modes which enable much faster optical response than current LCD modes are based on use of Smectic liquid crystal materials such Surface Stabilized Ferroelectric Liquid Crystal (SSFLC) displays, Anti-ferroelectric Liquid Crystal Displays (AFLCDs), Polarization Shielded Smectic Liquid Crystal Displays (PSS-LCDs), and so on. These Smectic liquid crystal base LCDs have common technical challenge. Due to smectic layer structure, they are in general vulnerable with mechanical stress. Once too much mechanical stress is applied to an LCD panel, smectic layer structure is very vulnerable and, if the mechanical stress is strong enough to destroy the layer structure, it is very difficult to reform the original layer structure without elevate temperature of the panel up to isotropic temperature. However, as long as using Smectic liquid crystal materials, it is inevitable to face this layer structure protection issue.

(State-of-the-Art-Technology to Reserve Smectic Layer Structure

There are several layer structure protection methods have been reported. In general current known technologies would be classified to following four categories. One is using specific spacer technologies, one is using external protection method outside the LC panel, one is using electric field assistance to stabilize smectic liquid crystal molecular alignment, and the other is using polymer stabilized of smectic liquid crystal materials inside the LC panel.

(Spacer Technologies)

In this category, two different approaches have been explored so far. One is using pillar spacers or wall type spacers to protect physical shape change of smectic liquid crystal panels. The other is to use adhesive spacer technology to glue two substrates firmly avoiding physical shape change due to mechanical stress.

For Smectic LCDs specifically, wall-shaped photo-spacers are proposed such as published Patent Application to Japanese Patent Office: “Kokai 2006-323222”, ibid “Kokai Hei-10-10520”. Regarding an active adhesive type of spacer technology is proposed as a Japanese Patent Number 3572550.

The wall-shape photo-spacer provides well enough mechanical strength, since its surface area to suspend upper grass substrate from external pressure is large enough. It is just like a building with many walls to support upper floors. However, this type of walls is very difficult to match with natural formation of Smectic layer structure. Unlike Nematic liquid crystal displays, Smectic liquid crystal displays need to satisfy both orientational order and translational order of liquid crystal material. Orientational order is commonly required for any type of liquid crystal materials in an LCD panel. It is a requirement for each liquid crystal molecule to align a certain direction. However, translational orientation is specifically required for liquid crystal materials which have layer structure. Translational order restricts each liquid crystal molecule to stay in certain layer and not allowed to move in other layers. The wall-shaped spacers work very well for a liquid crystal material which has only orientational order, because such a liquid crystal molecule can find out its aligning place avoiding wall area under the restriction of a certain directional molecular alignment.

However, Smectic liquid crystal molecule with strict restriction of translational order, it is extremely difficult to find out its proper aligning place avoiding wall spacer area, because, for Smectic liquid crystal case, its alignment is not simply restriction of single molecular direction, but multiple liquid crystal stacking alignment to form Smectic layer structure. Therefore, if the wall spacer locates at the middle of Smectic layer structure formation, the Smectic liquid crystal molecules could not form its layer structure, resulting in non-uniform molecular alignment. This situation is just like a tunnel construction. If some extremely unstable area locates juts in the middle of the scheduled rout of the construction, the planed tunnel could not keep the original rout. Since Smectic layer structure usually has 40 to 50 A layer spacing (a thickness of the layer), it is practically impossible to adjust wall spacer formation place on the glass substrate. 40 to 50 A are too small to control wall spacer formation using current any available technologies. Therefore, the wall-shaped photo-spacer does not solve required issue.

On the other hand, an active adhesive gluing spacer technology would be potentially matching with Smectic layer construction in an LCD panel. As the patent (a Japanese Patent Number 3572550) specifies that even area of supporting upper glass substrate is limited compared to the wall-shape spacer, its relatively strong adhesive strength prevents from change of panel gap due to external mechanical pressure. This technology is good for relatively low resolution LCD panels, or larger pixel sized LCD panels. As the Patent described that the glue particle needs to have a certain size to work as “glue”, otherwise, its adhesive strength does not show well enough performance. Moreover, this technology uses dispersing process in general, therefore, it is difficult to specify specific place to be located itself. Unlike photo-lithography process, dispersing particle process does not choose specific place. On the other hand, using photo-lithography process, embedded effective adhesive strength is very difficult to give the spacer material. Therefore, when high a resolution display, or a smaller sized pixel LCD is required using Smectic liquid crystal materials, the Patent technology does not work well.

(External Protection Method)

Regarding middle to large sized Smectic LCDs, it is well known to protect their frame covered by some sort of “shock absorber”. Canon sold an SSFLC (Surface Stabilized Ferroelectric Liquid Crystal) displays with this type of mechanical protection system. For relatively larger sized panel, an external mechanical protection system works, however, for small sized display system, or most of mobile displays systems, there is no particular room to be used for this type of external protection system. Therefore, it is required for practical method without consuming physical space. Moreover, even large display system, recent design demand is so called “narrow frame system in a screen” that requires the thinnest frame from the outer edge of effective screen. This design request does not allow having a thick frame area form the edge of an effective image area. As the above requirement from market trend, regardless display screen size, an external protection system is out of trend anymore.

(Electric Field Application)

Some of SSFLC (Surface Stabilized Ferroelectric Liquid crystal) displays are known to be capable of recovering their damaged alignment status by being applied with external electric field. Some damaged liquid crystal molecular alignment is set back to the original alignment status by driving the liquid crystal display. The principle of this mechanism is to align ferroelectric liquid crystal molecules with assistance of externally applied electric field. Actually this method works for some specific cases, in particular with relatively slight damaged liquid crystal molecular alignment. With liquid crystal molecular switching by externally applied electric field, a damaged liquid crystal molecule gradually recovers its original alignment status, resulting in recovering of whole area of molecular alignment. This method, however, has some problems. When the damage is relatively slight one, this works, but the damage is heavy one, this does not work. Moreover, this method potentially works only at electrode covered area, and does not work area not covered by electrodes. For all of matrix electrode LCDs, between electrodes area does not have any effect from electric field. Therefore, this method is not practical for most of LCDs except for a single electrode LC panel.

(Polymer Network Assistance Method)

Unlike above other methods, this method is to stabilize smectic liquid crystal layer structure intrinsically. A Japanese Patent Number 3215915 discloses this method. The mechanism of this method is to construct polymer chain structure in a Smectic liquid crystal layer structure. A main chain dominant monomer material is mixed with Smectic liquid crystal material. The UV curable monomer has good miscibility with the Smectic liquid crystal materials that means the monomer aligns along with the liquid crystal molecular alignment. Then, using an initiator material, the monomer material is polymerized by UV light. This polymerization basically preserve the original monomer alignment, therefore, the monomer forms a straightforward type of polymer wall.

This polymer wall structure is much longer than a smectic liquid crystal molecule, resulting in stabilization of the Smectic layer structure. The formed polymer walls work as if they are walls in an actual building. This method actually gives rise to some level of stability in the smectic layer structure. However, it is still not well enough to an actual use of LCD environment. Since, the polymer wall exists relatively in low density, otherwise, the Smectic liquid crystal molecular alignment itself is disturbed and could not obtain a clean molecular alignment. Moreover, even if a clean molecular alignment is obtained with high enough polymer wall density, due to too high density of polymer wall, the Smectic liquid crystal molecular movement is suppressed and could not obtain well enough switching properties. Therefore, this method is not practical in terms of stabilization of Smectic liquid crystal molecular alignment at an actual use.

### SUMMARY OF THE INVENTION

An object of the present invention is to provide practical solutions to the above-mentioned problems encountered in the prior art.

Another object of the present invention is to provide practical solutions to all of current required LCDs using Smectic liquid crystal displays as well as a heavy or tough mechanical stress environment is required regardless Smectic liquid crystal displays, Nematic liquid crystal displays.

The present invention is based on a pillar spacer technology, but is differentiate its concept in terms of mechanical strength against external pressure. A photo spacer is nowadays broadly in use for volume manufacturing of conventional LCDs regardless active matrix or passive matrix LCDs. However, above discussed issue is not solved yet. This is the reason why current well known and used photo spacer technology does not have any concept to protect against mechanical pressure that is extremely vulnerable to a certain type of liquid crystal panel.

Therefore, the concept of the present invention is to give more strength to basic concept of photo spacer technology. This strengthened mechanical power gives rise to a certain liquid crystal panel practical way to the market. Moreover, the new concept is not based on the purpose of obtaining a certain and uniform panel gap, but on the purpose of strong enough mechanical strength against external pressure. This particular effect based on the numerical analysis of mechanical strength of pillar spacers that prevents from change of panel gap against strong external pressure has not been discussed yet in public domain.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a graph showing pressure strength depending on pressure area

FIG. 2 is a graph showing Maximum load to a circle shaped pillar spacer depending on its diameter

FIG. 3 is a schematic plan view showing “round” shape pillar spacer.

FIG. 4 is a schematic plan view showing “cross” shape pillar spacer.

FIG. 5 is a schematic plan view showing “L” shape pillar spacer.

FIG. 6 is a schematic plan view showing “L-cross” shape pillar spacer.

FIG. 7 is a schematic plan view showing “T” shape pillar spacer.

FIG. 8 is a schematic plan view showing matrix type of wall spacers.

FIG. 9 is a schematic plan view showing patterned wall type pillar spacers.

FIG. 10 is a schematic plan view showing patterned wall type with round shape pillar spacers.

FIG. 11 is a schematic sectional view showing Pillar spacer height and diameter.

FIG. 12 is a schematic perspective view showing Pillar spacer height and diameter.

FIG. 13 is a schematic plan view showing Smectic layer structure and construction direction of the wall type pillar spacers.

FIG. 14 is an SEM (scanning electron microscope) image showing durability to the pressure apply to the “cross” shape pillar spacers.

FIG. 15 is an SEM image showing durability to the pressure apply to the “T” shape pillar spacers.

FIG. 16 is an SEM image showing durability to the pressure apply to the “round” shape pillar spacers.

FIG. 17 is an SEM image showing durability to the pressure apply to the thin “cross” shape pillar spacers.

FIG. 18 is an SEM image showing durability to the pressure apply to the fat “round” shape pillar spacers.

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

There are some published patents describe some particular shape of pillar type or photo spacers such as Japanese Published Patent: Kokai 2004-287227, and Kokai 2006-323213. These published patents describe some specific shape of pillar type of spacers. However, they do not discuss how these shapes contribute keeping uniform enough panel gap against external mechanical pressure. The present invention is based on specifically the strength to keep tenacious panel gap against externally applied pressure rather than to discuss formation of uniform panel gap. Therefore, some numerical analysis is essential in the present invention.

First of all, the Inventors looked into the mechanical performance of materials used in so-called photo spacers or pillar spacers. Since these types of spacers require photo lithography process, therefore an applicable material is somehow limited. Acrylic resin is the most widely used in the present invention. Most of acrylic resin has well enough mechanical compression performance such as 76 MPa in general. In the nature of spacer, its size and formation place in a liquid crystal panel have some restriction. For instance, at a TFT-LCD, most of pillar type spacers are formed behind gate line, and data line. Because, these lines are formed by metal, therefore, behind these lines are blind to LCD viewer. Moreover, most of resin has smaller dielectric constant than that of liquid crystal materials, the blind area in an LCD is helpful to be occupied by smaller dielectric constant material in terms of power consumption. Therefore, there may have the idea that all of blind area or black matrix covered area in a TFT-LCD would be covered by pillar type of spacers. However, too much pillar or wall shaped spacers provide some problems.

One is manufacturing problem, in particular liquid crystal filling process. Due to too many spacer walls, liquid crystal fill process takes long time, or even worse, it is difficult to fill everywhere in a matrix shapes wall type spacers. The other problem is reliability related matter. It is extremely difficult to have a perfect matching of thermal expansion coefficient both at liquid crystal material and pillar spacer material. Due to difference in thermal expansion coefficient, thermal change provides air bubbles in an LC panel, in particular low temperature range. Moreover, in a high resolution type of LCDs, too much spacer walls decreases aperture ratio, resulting in dim screen luminance, or requirement of more power for backlight unit. Based on above discussions, the present invention investigated some sort of specific balance between requirement of mechanical strength and requirement of display performance.

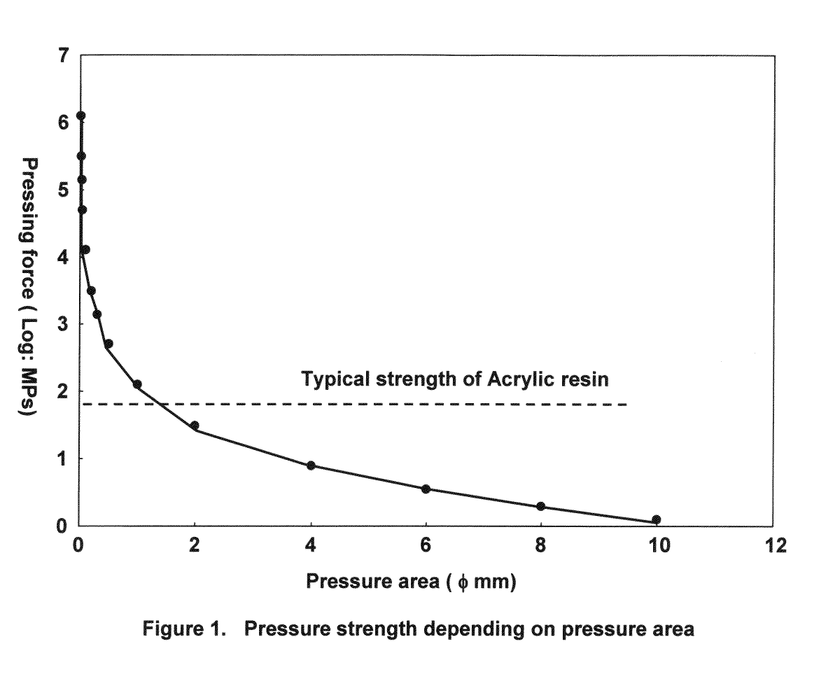

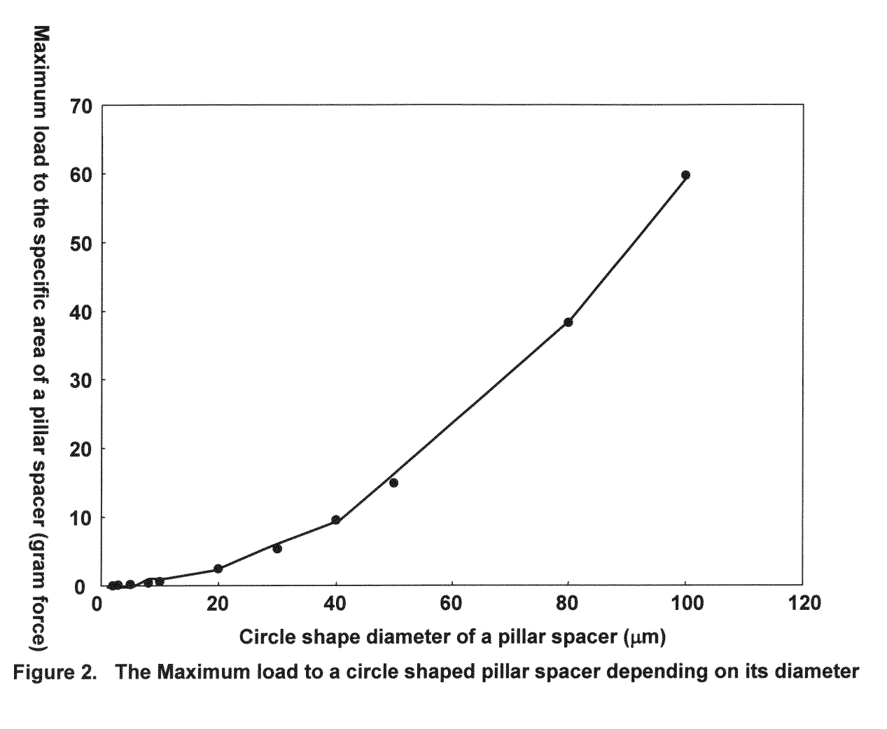

In order to meet with mechanical stress requirement, in particular with recent very harsh requirement, first of all, we looked into the mechanical performance of acrylic resin. In general, the strength of acrylic resin for expansion is around 76 MPs. Although most of current commercially used pillar spacers are made of Acrylic resin, the type of resin is not limited in Acrylic resin. The requirement is photo-process capability and having well enough mechanical strength as well as non disturbing, non harmful properties to liquid crystals molecular alignment. A typical criterion to the mobile application display in terms of mechanical stress is 4 kgf/φφ 5 mm. However, recent harsh criterion sometimes requires more mechanical stress resistance. Therefore, we have set 5 kgf/φ 2 mm as the harshest case. In order to compare the harshest case with a typical acrylic resin's mechanical strength, 5 kgf/φ 2 mm is converted to MPa. The converted value is 15.93 MPs. For the current required criterion to the mechanical pressure of 4 kgf/φ 5 mm is converted to 2.04 MPs. FIG. 1 shows the relationship between pressing force and the pressure area. FIG. 2 also shows the maximum load to the specific area of a pillar spacer. Based on these two primary values, we had following numerical investigation to clarify mechanical strength required to pillar spacers.

For the numerical investigation of mechanical strength of pillar spacers, we had following postulation.
(a) For preliminary investigation, we fixed a certain density, shape and size of pillar spacer. The pillar spacer has a round shape of area and columnar shape.

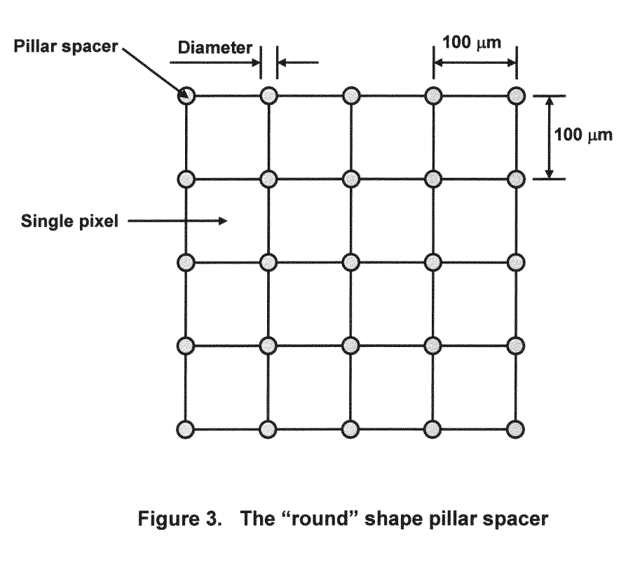

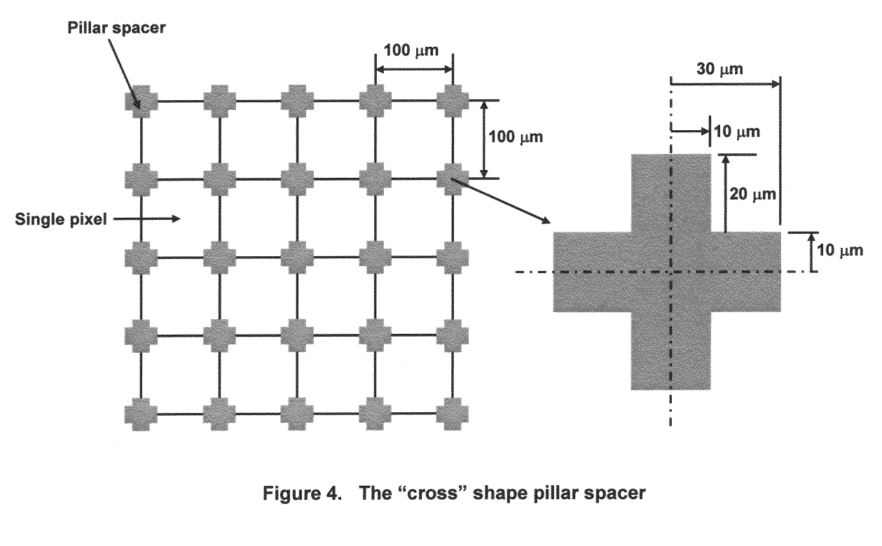

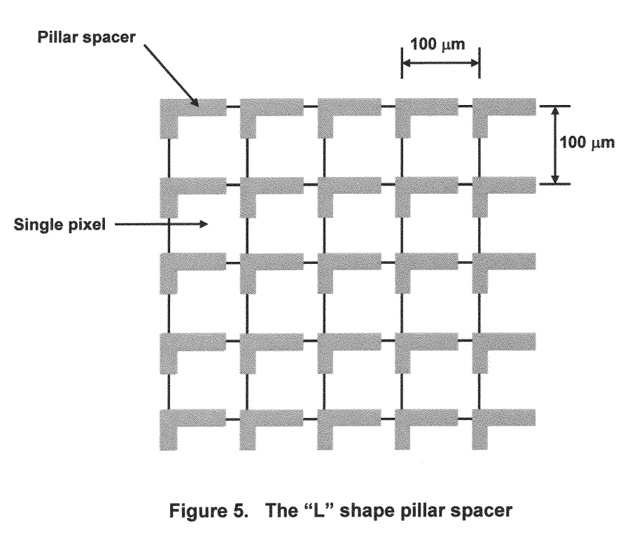

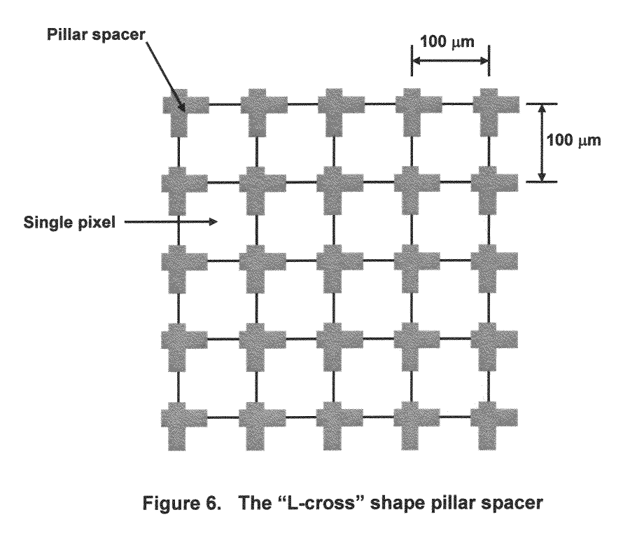

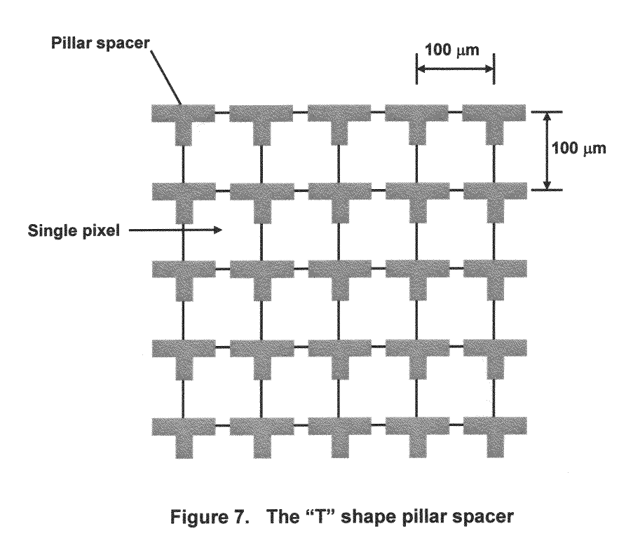

Its diameter is 20 μμm, and its density is every 100 μm×100 μm in an LCD panel as illustrated in FIG. 3. The force of 15.93 MPs is applied to φ 2 mm area that is 1 mm×1 mm×π˜3.14 mm²=3.14×10⁶ μm². When a φ 20 μm pillar spacer is constructed at every 100 μm×100 μm, there are (3.14×10⁶ μm²)/1×10⁴ μm²=3.14×10² pieces of pillar spacers in 3.14×10⁶ μm area. Therefore, the force of 5 kgf/φ 2 mm should be supported by 3.14×10² pieces of pillars. 5,000 gf/3.14×102 pieces=15.92 gf/piece>>2.386 gf which is the maximum pressure of φ 20 μm pillar spacer. Therefore, f 20 mm pillar spacer with its density of every 100 μm×100 μm could not support the pressure of 15.93 MPs with the pressure area of φ 2 mm. In order to have well enough supporting power against 15.93 MPs, roughly 15.92/2.386=6.67 times of area with pillar spacer surface should be required. When the spacer surface shape is kept with circler, its diameter would be 52.92 μm [(52.92/2 μm×52.92/2 μm×π)/(10 μm×10 μm×π)=7)] to support 15.93 MPs. However, diameter of 52.92 μm at every 100 μm×100 μm area makes aperture ratio extremely small, resulting in very dim screen luminance.
In case of current standard criterion of 4 kgf/φ 5 mm leads to 2.038 gf/piece. This value is a little smaller than the maximum pressure value of acrylic resin of 2.386 gf. However, in actual use of mobile displays, pressure is not always applied by plane surface, but rather applied with sharp tip, therefore, substantial applied pressure is not like 2.038 gf/piece, but at least 5 time larger value of 10 gf/piece. This requires at least 10/2.386=4.19 times of area with pillar spacer surface should be required. 4.19 times of area is equivalent with 15.7% of every 100 μm×100 μm area. (314 μm²×5/(100 μm×100 μm))
(b) In order to avoid too much reduction of aperture ratio, but should have well enough mechanical strength, “cross” shaped pillar spacer as illustrated in FIG. 4 is investigated if it could have well enough mechanical strength without sacrificing aperture ratio. The “cross” shaped pillar spacer illustrated in FIG. 4 has total area S of S=(20 μm×20 μm)×5=2,000 μm². This area of 2,000 μm² is about 6.4 times larger than that at the area of φ 20 μm pillar spacer. However, this is still smaller than that would support the power of 15.93 MPs. Then, slightly larger “cross” shaped spacer is designed. S′=(22 μm×22 μm)×5=2,420 μm² that is 7.7 times larger than that with φ 20 μm spacer. This S′ also needs to meet with density of spacers such as at every 100 μm×100 μm. This area of 2,420 μm² is equivalent of 24.2% to the total area of 100 μm×100 μm.
(c) In terms of mechanical supporting performance, large enough area of pillar spacers with minimizing reduction of aperture ratio is the most important requirement. When the present invention is applied to a TFT type of LCD, above discussed “cross” shaped pillar spacer minimizes decrease of aperture ratio. Since TFT LCDs require both data line and gate line, and these lines are covered by black matrix. At the most of TFT-LCDs, width of gate and data lines has about 20 mm for registration accuracy requirement for panel lamination. Therefore, above mentioned 22 μm wide “cross” shaped pillar spacer sacrifices only 2 μm width from black matrix.
(d) For avoiding any loss at aperture ratio, “L” shape pillar spacer is also effective to satisfy both mechanical supporting and no sacrificing any aperture ratio. As shown in FIG. 5, long side of “L” shape should have the length of 65 μm with short side of “L” shape of 45 μm to meet with well enough mechanical strength. In this particular shape of “L” spacer shown in FIG. 5 has 22% of area in 100 μm×100 μm. This particular “L” shape pillar spacer does not sacrifice any aperture ratio as long as this shape of pillar spacer is applied to TFT type of LCDs. This “L” shape pillar spacer also needs to meet with density of spacers such as at every 100 μm×100 μm. One of the modified pillar spacer shapes, “L-cross” shape illustrated in FIG. 6 is also effective to provide the benefit of the Invention.
(e) For avoiding any loss at aperture ratio, “T” shape pillar spacer is also effective to satisfy both mechanical supporting and no sacrificing any aperture ratio. As shown in FIG. 7, upper side of “T” shape may have the length of 60 μm with foot side of “T” shape of 50 μm to meet with well enough mechanical strength. This “IT” shape has 22% of spacer area to 100 μm×100 μm area. This particular “T” shape pillar spacer does not sacrifice any aperture ratio as long as this shape of pillar spacer is applied to TFT type of LCDs. This “T” shape pillar spacer also needs to meet with density of spacers such as at every 100 μm×100 μm.
(f) As above discussed specific shapes of pillar spacers need to satisfy both specific mechanical strength that is decided by top surface area of pillar spacers, and to avoid any reduction of aperture ratio to keep bright enough screen luminance. Therefore, the intrinsic requirement of the pillar spacer is followings.
   (1) The top surface of each area of pillar spacer with specific density needs to have well enough mechanical strength.
   (2) When the density of pillar spacer is at every 100 μm×100 μm, the top surface of each area of pillar spacer should have minimum size of 2,200 μm².
   (3) The pillar spacer should be covered by black matrix of a TFT-LCD substrate.
   (4) Therefore, the shape of pillar spacer is secondary matter. The intrinsic requirement is to satisfy both well enough mechanical strength near to pillar spacer material's limit and not sacrificing any aperture ratio covered by black matrix.

The other requirement of pillar spacer is followings.
(1) To prevent from disturbing liquid crystal filling process
(2) To prevent from disturbing mechanical buffing process
(3) To prevent from disturbing Smectic liquid crystal molecular alignment
(a) Liquid crystal filling process

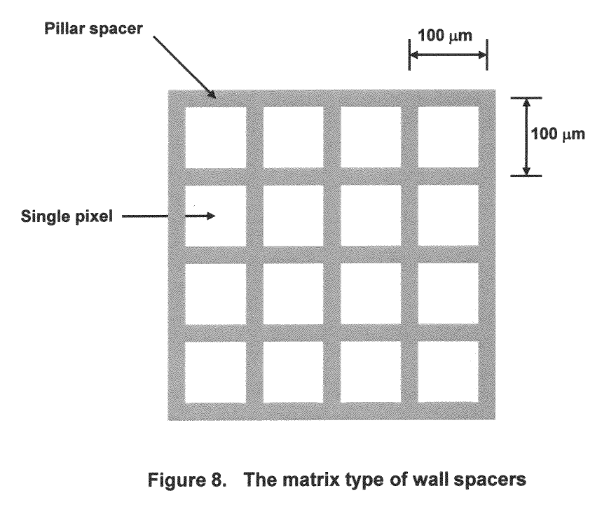

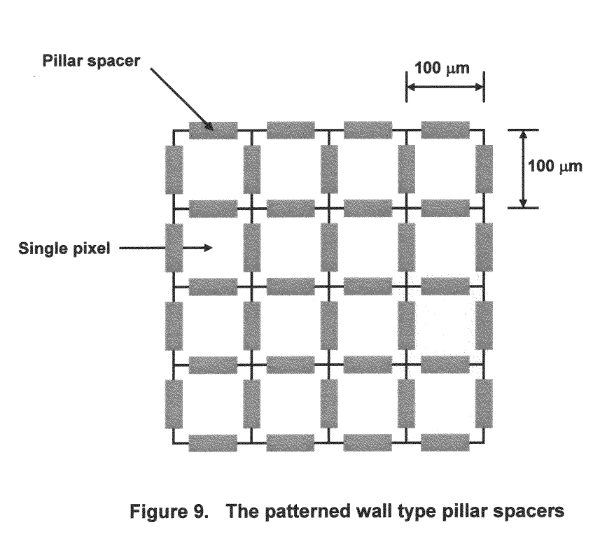

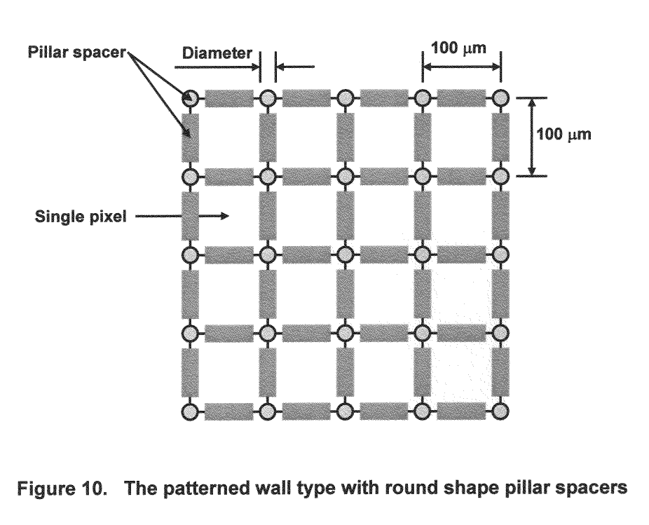

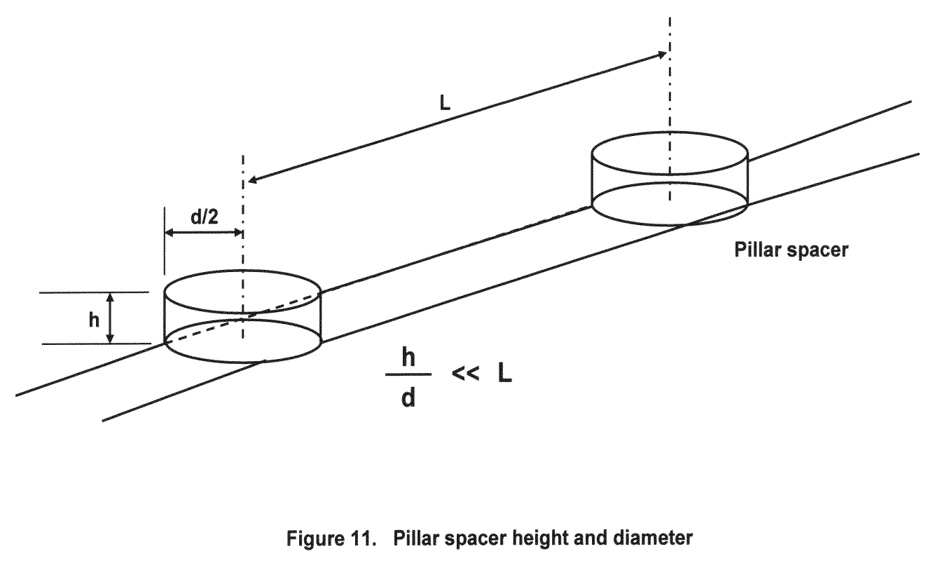

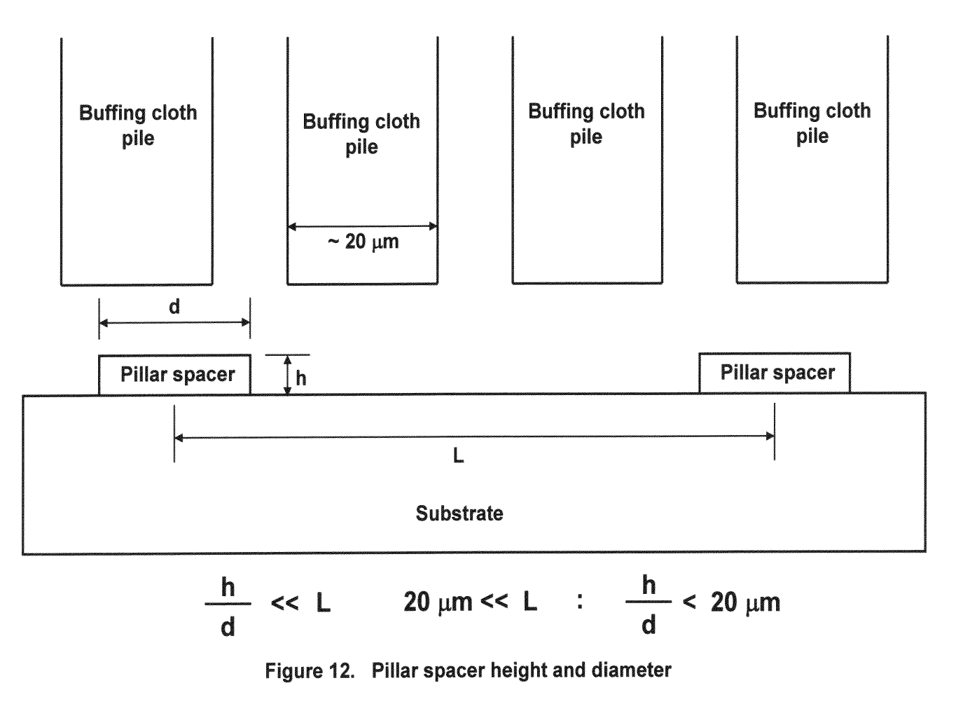

In order to satisfy strong enough mechanical strength without sacrificing any aperture ratio, the maximum area of pillar spacer is to construct all of area covered by both gate and data lines as shown in FIG. 8. However, it is clear that the shape shown in FIG. 8 does not allow liquid crystal material filling due to surrounded walls. Therefore, this type of pillar spacer is not practical. In order to avoid this problem at liquid crystal filling process, some portions of wall type of pillar spacers should have slit-wise area as shown in FIGS. 9 and 10 depending on liquid crystal filling process and throughput. FIG. 9 would be designated as “Patterned wall” shape pillar spacer, and FIG. 10 would be designated as “Patterned wall with round shape pillar” shape spacer.
(b) Mechanical buffing process
   This is about distance between neighboring pillar spacer. When the distance between neighboring pillar spacers is too short, buffing pile may not be able to buff the distance, resulting in inadequate buffing effect. Therefore, in another word, this is about density and size of pillar spacers. Based on current volume manufacturing condition, conventional buffing uses the contact length of buffing cloth pile between 0.1 mm to 0.5 mm. Since most of buffing cloth has much longer buffing cloth pile than that of height of pillar spacer which is usually 1 to 5 μm, it is reasonably assumed that even very high density pillar spacers may not disturb buffing effect on the alignment layer. As a matter of fact, due to high throughput of mfg process at buffing. It sometimes skips buffing effect at very foothill of pillar spacers. When buffing roller is rotated very fast, the edge of buffing cloth pile could not keep its pile direction perpendicular to the surface of buffing roller due to very strong centrifugal force, resulting in lying of pile edge to buffing roller. This lying of pile edge weakens buffing effect on the alignment layer surface. This problem is somehow avoidable to slow down buffing process, however, slowing down of the buffing process results in lower mfg throughput. Therefore, wide enough distance between neighboring spacers is required. The allowable distance between neighboring pillar spacers in terms of well enough buffing effect at volume mfg is actually decided by mutual relationship between the height of pillar spacer, the top surface area of the spacer, and the distance of neighboring pillar spacers as presented both in FIG. 11 and FIG. 12. As shown both in FIG. 11 and FIG. 12, in general shorter the height “h” of pillar spacer gives shorter the allowable distance “L”. When the diameter of round shape pillar spacer is “d”, the allowable condition to avoid insufficient buffing effect with fast enough buffing process is shown as

$$\frac{h}{d} << L.$$

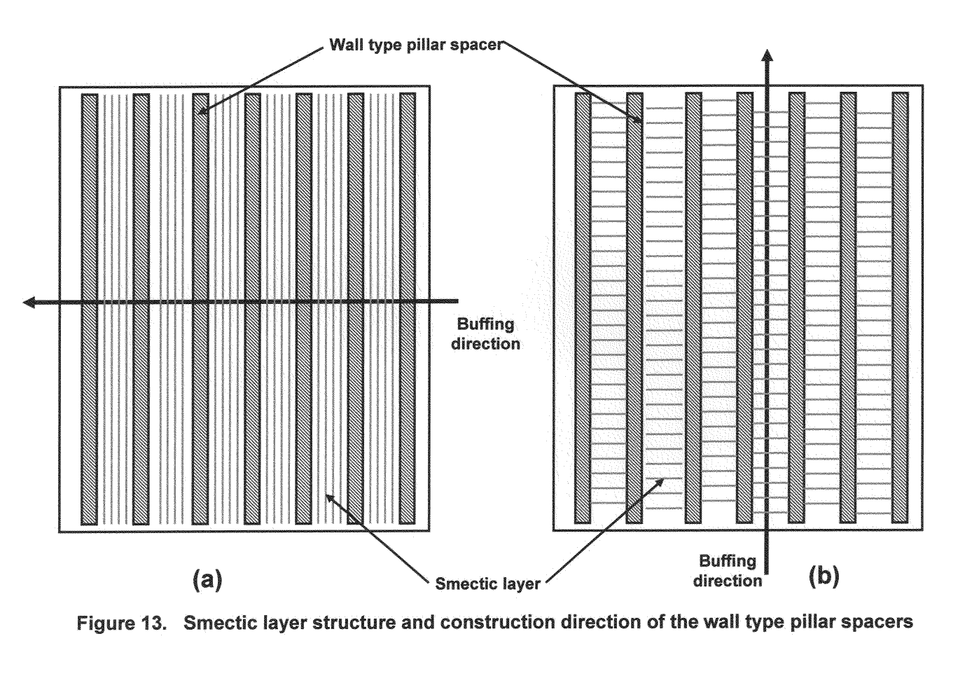

(c) Preserving Smectic liquid crystal molecular alignment
   Unlike Nematic liquid crystal molecules, Smectic liquid crystal molecules need to form Smectic layer structure as shown in FIG. 13. With some reason, if the Smectic layer structure is disturbed, it is very difficult to obtain a clean molecular alignment. In order for Smectic layer structure to form their natural structure, a pillar spacer shape, structure, density and relative direction with buffing direction are most important to keep specific relation.
   For instance, if straight wall shape of pillars is constructed, the Smectic layer structure is formed as illustrated in FIG. 13, depending on the relative direction between wall pillar direction and buffing direction. In this case as shown in FIG. 13(a), buffing effect has some difficulty due to straight wall pillar structures regardless above discussion at (b). However, in this case, the obtained Smectic layer structure is along with the wall direction, therefore, the Smectic liquid crystal molecular alignment is generally very clean. On the contrary, when buffing direction is along with the straight wall direction such as shown in FIG. 13(b), the buffing effect is effective enough. In this case, Smectic layer structure is formed perpendicular to the straight wall type pillar spacers as shown in FIG. 13(b). Since Smectic layer structure is interrupted by wall type pillar spacers, this type of layer structure does not give clean molecular alignment.
   Therefore, in order to make well enough balance between mechanical strength and clean molecular alignment, it is extremely important to consider trade-off issue between these two important factors.
(d) Specific balance between mechanical strength and Smectic layer structure formation
   As discussed above, it is intrinsic requirement to have a balance between mechanically strong enough pillar spacer structure and having a clean enough Smectic liquid crystal molecular alignment. For strong enough mechanical strength against external pressure requires above discussed requirement with numerical condition depending on pillar spacer materials physical strength and their shape as pillar spacer. For obtaining a clean Smectic liquid crystal molecular alignment, it is intrinsic to form natural Smectic layer structure as discussed above. In order to have a natural Smectic layer structure, long enough layer structure needs to be formed. Therefore, pillar spacer itself is some sort of hazard to the formation of natural Smectic layer structure. In this particular point, it is preferable to have no pillar spacers. However, without an effective shape of pillar spacers, it is impossible to protect clean molecular alignment from external pressure. Therefore, the basic concept to balance these two conflict factors is to minimize disturbing Smectic layer structure formation in the pillar spacer structure. Based on this concept, the most important requirement to have a clean molecular alignment is to maximize Smectic layer structure with minimizing interruption of Smectic layer splitting by pillar spacers. In this point, long continuing pillar structure such as wall type may not be effective. On the other hand, a wall type of pillar structure is very effective to protect Smectic liquid crystal molecular alignment in terms of mechanical strength.

Above consideration naturally leads following solution to balance two trade-off matters. First of all, large enough pillar spacer surface area to protect Smectic liquid crystal molecular alignment is the most required. The well enough surface area of pillar spacers is discussed in this section. Depending on pillar spacer material's physical performance, the required total area of spacer surface including the density of spacer distribution is decided. Most of the case using acrylic resin pillar spacer, the required surface area is 2,200 μm² at every 100×100 μm², which is 22% of total area in an liquid crystal panel at the most of cases using acrylic resin as discussed at the early portion of this section. This 22% of area would be taken account into the covering area by black matrix at a TFT-LCD. For higher aperture ratio, most of the pillar spacers must be constructed at the gate line and data line area. This requirement to maximize aperture ratio keeping strong enough mechanical strength as a spacer automatically gives preferable shape of pillar spacers. Since most of TFT-LCDs have matrix type of gate and data lines to maximize aperture ratio, straight line shape of pillar spacers would satisfy the requirement both for mechanical strength and high enough aperture ratio.

The other requirement is Smectic liquid crystal molecular alignment under the specific requirement that is natural Smectic layer structure. In this particular requirement, it is obvious that the straight shape of pillar spacers need some split to construct the minimum interrupted Smectic layer structure. This concept leads to “cross” shape, “T” shape, “L” shape and some “broken-line” shape pillar spacers. Moreover, most of these pillar spacers must be constructed at gate and data lines area to maximize aperture ratio. As discussed above, not only total top surface area of pillar spacers, but their distribution density is also of very important. An expected mechanical pressure may not specify its pressure applied place at a surface of an LCD, therefore, all of LCD surface needs to prepare strong enough resistance against mechanical pressure. Therefore, uniform distribution of pillar spacer construction to distribute pressure applied to a certain point at a surface of an LCD.

As the conclusion of the requirement of the present invention, followings are stated.
(a) Taking account into pillar spacer materials performance, the top surface area of pillar spacer requires over 15% of total active image area including area covered by black matrix.
(b) Preferably, its area is over 22%
(c) These pillar spacers must be constructed with above density and most equally distributed at an TFT-LCD panel to distribute externally applied pressure
(d) In order to maximize aperture ratio, above pillar spacers must be constructed on the gate and the data lines covered by black matrix
(e) The constructed pillar spacers should not disturb Smectic liquid crystal molecular alignment in practical manner
(f) The constructed pillar spacers would have their shape of “cross”, “T”, “L” and “broken-line” shapes to prevent from disturbing Smectic liquid crystal molecular alignment
   Hereinbelow, the present invention will be described in more detail with reference to specific Examples.

### EXAMPLES

### Example 1

(The Present Invention)

Using 50 mm×50 mm×0.5 mm thickness size of ITO coated glass substrates these glass substrates were cleaned by alkaline detergent with applying ultrasonic 20 minutes. After rinsed by DI water, these substrates were dried in a clean oven at 110 degrees C., 40 minutes. Using these substrates, “cross” shaped pillar spacers were prepared. The “cross” shaped pillar spacers were formed as following. Using in-house photo reactive acrylic monomer solution, it is coated on the cleaned glass substrates using a spin coating machine. After the spin coating, the thickness of the coated layer was 1.8˜1.9 micron. This layer was baked at 200 degrees C., 40 minutes. The thickness was measured by a needle type measurement system after curing of the layer. After the layer is cured, this substrate is stacked with a photo-mask having “cross” shaped. Using a super high pressure mercury lamp, the substrates is exposed by g, h, and i wavelength mixed light. The total exposure energy of the light was 300 mJ/cm². The exposure system used in this experiment was a proximity method. After the light exposure, the acrylic resin was developed by using 0.4 wt % of TMAH (Tetra Methyl Ammonium Hydroxide) solution. at 23 degrees C. with 60 seconds condition. After the development, then, the substrate was rinsed by using DI water with 60 seconds, and finally the substrate was dried at 50 degrees C., 40 minutes. The obtained “cross” shaped spacer area has 2,200 μm², and the 2,200 μm² area is placed at every 100×100 μm², which results in 22% of spacer sustained area at a liquid crystal panel.

After the “cross” shaped pillar spacers were prepared, a pair of the pillared and non-pillared substrates was coated with poly-imide alignment layer with 500 A thickness. These substrates were mechanically buffed with the buffing machine under the condition of 0.3 mm contact length, one pass buffing. The buffing direction is parallel with one edge of the substrate and relative direction of the buffing with a pair of substrates was parallel. Then these two substrates were laminated using a hot-press lamination system with 2 kg/cm² pressure and heated the lamination at 145 degrees C. to cure perimeter seal material coated at the perimeter area of the substrate. 3 mm width area was left open at the perimeter seal area for liquid crystal filling process.

After the lamination was completed, a house-made PSS-LC material mixture which is a part of Smectic liquid crystal mixture (refer to US published patent application: 2004/0196428) was filled with the pressure difference method. After the liquid crystal material was filled in the panel, the filling hole was tipped-off by using UV curable resin. The obtained liquid crystal molecular alignment in this “cross” shaped pillar spacer made of acrylic resin panel was quite clean and uniform.

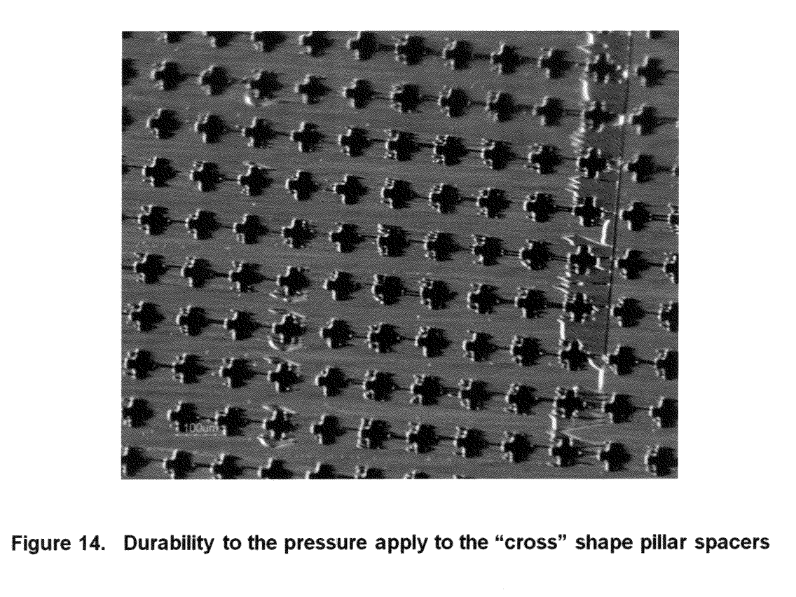

Using panels prepared by above, mechanical strength was measured using commercially available pressuring machine: MX-500N-E made by IMADA Co., Ltd. Japan. Using φ 5 mm pressure cylinder tip, several amount of pressures were applied. FIG. 14 shows the result of the PSS-LC molecular alignment after the application of pressure. As shown in the FIG. 14, it was confirmed that the equivalent pressure of 5 kg/φ 2 mm did not provide any significant change in the molecular alignment. The size of the specific “cross” shaped pillar spacer is 2,200 μm² each, therefore, this size of pillar spacer does not reduce aperture ratio significantly.

### Example 2

(The Present Invention with Different Shape of Spacer)

Using 50 mm×50 mm×0.5 mm thickness size of ITO coated glass substrates these glass substrates were cleaned by alkaline detergent with applying ultrasonic 20 minutes. After rinsed by DI water, these substrates were dried in a clean oven at 110 degrees C., 40 minutes. Using these substrates, “T” shaped pillar spacers were prepared. The “T” shaped pillar spacers were formed as following. Using in-house photo reactive acrylic monomer solution, it is coated on the cleaned glass substrates using a spin coating machine. After the spin coating, the thickness of the coated layer was 1.8˜1.9 micron. This layer was baked at 200 degrees C., 40 minutes. The thickness was measured by a needle type measurement system after curing of the layer. After the layer is cured, this substrate is stacked with a photo-mask having “T” shaped. Using a super high pressure mercury lamp, the substrates is exposed by g, h, and i wavelength mixed light. The total exposure energy of the light was 300 mJ/cm². The exposure system used in this experiment was a proximity method. After the light exposure, the acrylic resin was developed by using 0.4 wt % of TMAH (Tetra Methyl Ammonium Hydroxide) solution. at 23 degrees C. with 60 seconds condition. After the development, then, the substrate was rinsed by using DI water with 60 seconds, and finally the substrate was dried at 50 degrees C., 40 minutes. The obtained “T” shaped spacer area has 2,400 μm², and the 2,200 μm² area is placed at every 100×100 μm², which results in 24% of spacer sustained area at a liquid crystal panel.

After the “T” shaped pillar spacers were prepared, a pair of the pillared and non-pillared substrates was coated with poly-imide alignment layer with 500 A thickness. These substrates were mechanically buffed with the buffing machine under the condition of 0.3 mm contact length, one pass buffing. The buffing direction is parallel with one edge of the substrate and relative direction of the buffing with a pair of substrates was parallel. Then these two substrates were laminated using a hot-press lamination system with 2 kg/cm² pressure and heated the lamination at 145 degrees C. to cure perimeter seal material coated at the perimeter area of the substrate. 3 mm width area was left open at the perimeter seal area for liquid crystal filling process.

After the lamination was completed, a house-made PSS-LC material mixture which is a part of Smectic liquid crystal mixture (refer to US published patent application: 2004/0196428) was filled with the pressure difference method. After the liquid crystal material was filled in the panel, the filling hole was tipped-off by using UV curable resin. The obtained liquid crystal molecular alignment in this “cross” shaped pillar spacer made of acrylic resin panel was quite clean and uniform.

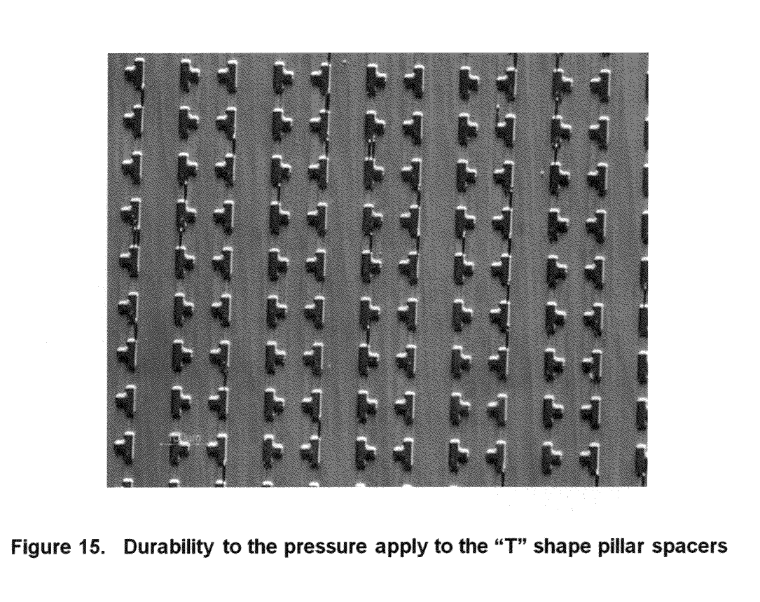

Using panels prepared by above, mechanical strength was measured using commercially available pressuring machine: MX-500N-E made by IMADA Co., Ltd. Japan. Using φ 5 mm pressure cylinder tip, several amount of pressures were applied. FIG. 15 shows the result of the PSS-LC molecular alignment after the application of pressure. As shown in the FIG. 15, it was confirmed that the equivalent pressure of 5 kg/φ 2 mm did not provide any significant change in the molecular alignment. The size of the specific “cross” shaped pillar spacer is 2,200 μm² each, therefore, this size of pillar spacer does not reduce aperture ratio significantly.

### Example 3

(Control)

Using 50 mm×50 mm×0.5 mm thickness size of ITO coated glass substrates these glass substrates were cleaned by alkaline detergent with applying ultrasonic 20 minutes. After rinsed by DI water, these substrates were dried in a clean oven at 110 degrees C., 40 minutes. Using these substrates, “round” shaped pillar spacers were prepared. The “round” shaped pillar spacers were formed as following. Using in-house photo reactive acrylic monomer solution, it is coated on the cleaned glass substrates using a spin coating machine. After the spin coating, the thickness of the coated layer was 1.8˜1.9 micron. This layer was baked at 200 degrees C., 40 minutes. The thickness was measured by a needle type measurement system after curing of the layer. After the layer is cured, this substrate is stacked with a photo-mask having “round” shaped. Using a super high pressure mercury lamp, the substrates is exposed by g, h, and i wavelength mixed light. The total exposure energy of the light was 300 mJ/cm². The exposure system used in this experiment was a proximity method. After the light exposure, the acrylic resin was developed by using 0.4 wt % of TMAH (Tetra Methyl Ammonium Hydroxide) solution. at 23 degrees C. with 60 seconds condition. After the development, then, the substrate was rinsed by using DI water with 60 seconds, and finally the substrate was dried at 50 degrees C., 40 minutes. The obtained “round” shaped spacer area has 314 μm², and the 314 μm area is placed at every 100×100 μm², which results in 3.14% of spacer sustained area at a liquid crystal panel.

After the “round” shaped pillar spacers were prepared, a pair of the pillared and non-pillared substrates was coated with poly-imide alignment layer with 500 A thickness. These substrates were mechanically buffed with the buffing machine under the condition of 0.3 mm contact length, one pass buffing. The buffing direction is parallel with one edge of the substrate and relative direction of the buffing with a pair of substrates was parallel. Then these two substrates were laminated using a hot-press lamination system with 2 kg/cm² pressure and heated the lamination at 145 degrees C. to cure perimeter seal material coated at the perimeter area of the substrate. 3 mm width area was left open at the perimeter seal area for liquid crystal filling process.

After the lamination was completed, a house-made PSS-LC material mixture which is a part of Smectic liquid crystal mixture (refer to US published patent application: 2004/0196428) was filled with the pressure difference method. After the liquid crystal material was filled in the panel, the filling hole was tipped-off by using UV curable resin. The obtained liquid crystal molecular alignment in this “round” shaped pillar spacer made of acrylic resin panel was quite clean and uniform.

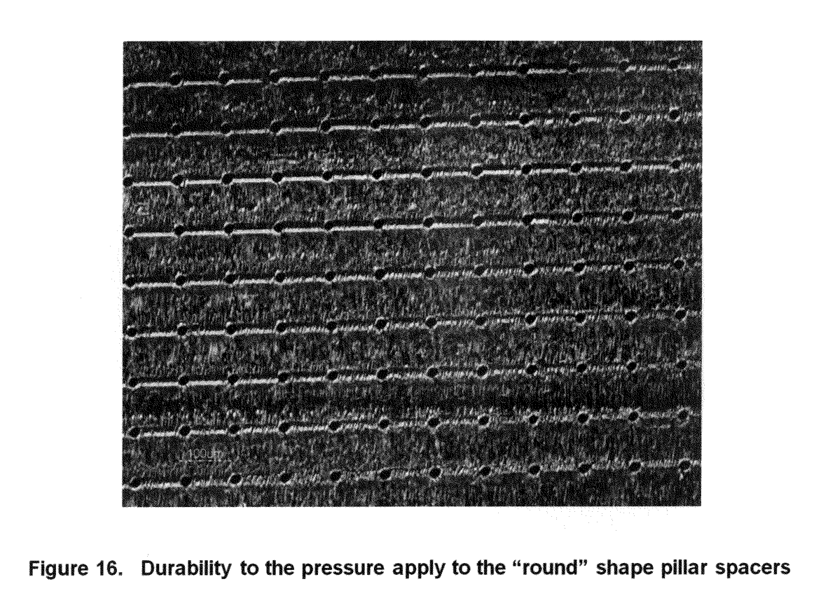

Using panels prepared by above, mechanical strength was measured using commercially available pressuring machine: MX-500N-E made by IMADA Co., Ltd. Japan. Using φ 5 mm pressure cylinder tip, several amount of pressures were applied. FIG. 16 shows the result of the PSS-LC molecular alignment after the application of pressure. As shown in the FIG. 16, it was confirmed that the equivalent pressure of 5 kg/φ 2 mm provided significant change in the molecular alignment. The size of the specific “round” shaped pillar spacer is 314 μm² each, therefore, this size of pillar spacer does not reduce aperture ratio significantly.

### Example 4

(Control)

Using 50 mm×50 mm×0.5 mm thickness size of ITO coated glass substrates these glass substrates were cleaned by alkaline detergent with applying ultrasonic 20 minutes. After rinsed by DI water, these substrates were dried in a clean oven at 110 degrees C., 40 minutes. Using these substrates, “cross” shaped pillar spacers were prepared. The “cross” shaped pillar spacers were formed as following. Using in-house photo reactive acrylic monomer solution, it is coated on the cleaned glass substrates using a spin coating machine. After the spin coating, the thickness of the coated layer was 1.8˜1.9 micron. This layer was baked at 200 degrees C., 40 minutes. The thickness was measured by a needle type measurement system after curing of the layer. After the layer is cured, this substrate is stacked with a photo-mask having “cross” shaped. Using a super high pressure mercury lamp, the substrates is exposed by g, h, and i wavelength mixed light. The total exposure energy of the light was 300 mJ/cm². The exposure system used in this experiment was a proximity method. After the light exposure, the acrylic resin was developed by using 0.4 wt % of TMAH (Tetra Methyl Ammonium Hydroxide) solution. at 23 degrees C. with 60 seconds condition. After the development, then, the substrate was rinsed by using DI water with 60 seconds, and finally the substrate was dried at 50 degrees C., 40 minutes. The obtained “cross” shaped spacer area has 500 μm², and the 500 μm² area is placed at every 100×100 μm², which results in 5% of spacer sustained area at a liquid crystal panel.

After the “cross” shaped pillar spacers were prepared, a pair of the pillared and non-pillared substrates was coated with poly-imide alignment layer with 500 A thickness. These substrates were mechanically buffed with the buffing machine under the condition of 0.3 mm contact length, one pass buffing. The buffing direction is parallel with one edge of the substrate and relative direction of the buffing with a pair of substrates was parallel. Then these two substrates were laminated using a hot-press lamination system with 2 kg/cm² pressure and heated the lamination at 145 degrees C. to cure perimeter seal material coated at the perimeter area of the substrate. 3 mm width area was left open at the perimeter seal area for liquid crystal filling process.

After the lamination was completed, a house-made PSS-LC material mixture which is a part of Smectic liquid crystal mixture (refer to US published patent application: 2004/0196428) was filled with the pressure difference method. After the liquid crystal material was filled in the panel, the filling hole was tipped-off by using UV curable resin. The obtained liquid crystal molecular alignment in this “cross” shaped pillar spacer made of acrylic resin panel was quite clean and uniform.

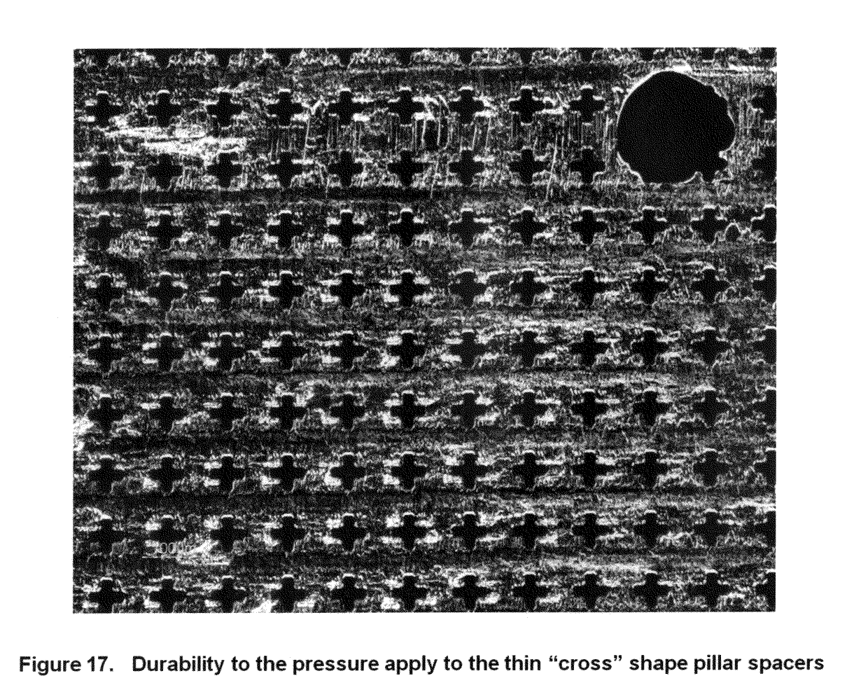

Using panels prepared by above, mechanical strength was measured using commercially available pressuring machine: MX-500N-E made by IMADA Co., Ltd. Japan. Using φ 5 mm pressure cylinder tip, several amount of pressures were applied. FIG. 17 shows the result of the PSS-LC molecular alignment after the application of pressure. As shown in the FIG. 17, it was confirmed that the equivalent pressure of 5 kg/φ2 mm provided significant change in the molecular alignment. The size of the specific “round” shaped pillar spacer is 500 μm² each, therefore, this size of pillar spacer does not reduce aperture ratio significantly.

### Example 5

(Control)

Using 50 mm×50 mm×0.5 mm thickness size of ITO coated glass substrates these glass substrates were cleaned by alkaline detergent with applying ultrasonic 20 minutes. After rinsed by DI water, these substrates were dried in a clean oven at 110 degrees C., 40 minutes. Using these substrates, “round” shaped pillar spacers were prepared. The “round” shaped pillar spacers were formed as following. Using in-house photo reactive acrylic monomer solution, it is coated on the cleaned glass substrates using a spin coating machine. After the spin coating, the thickness of the coated layer was 1.8˜1.9 micron. This layer was baked at 200 degrees C., 40 minutes. The thickness was measured by a needle type measurement system after curing of the layer. After the layer is cured, this substrate is stacked with a photo-mask having “round” shaped. Using a super high pressure mercury lamp, the substrates is exposed by g, h, and i wavelength mixed light. The total exposure energy of the light was 300 mJ/cm². The exposure system used in this experiment was a proximity method. After the light exposure, the acrylic resin was developed by using 0.4 wt % of TMAH (Tetra Methyl Ammonium Hydroxide) solution. at 23 degrees C. with 60 seconds condition. After the development, then, the substrate was rinsed by using DI water with 60 seconds, and finally the substrate was dried at 50 degrees C., 40 minutes. The obtained “round” shaped spacer area has 1,254 μm², and the 1,254 μm² area is placed at every 100×100 μm², which results in 12.54% of spacer sustained area at a liquid crystal panel.

After the “round” shaped pillar spacers were prepared, a pair of the pillared and non-pillared substrates was coated with poly-imide alignment layer with 500 A thickness. These substrates were mechanically buffed with the buffing machine under the condition of 0.3 mm contact length, one pass buffing. The buffing direction is parallel with one edge of the substrate and relative direction of the buffing with a pair of substrates was parallel. Then these two substrates were laminated using a hot-press lamination system with 2 kg/cm² pressure and heated the lamination at 145 degrees C. to cure perimeter seal material coated at the perimeter area of the substrate. 3 mm width area was left open at the perimeter seal area for liquid crystal filling process.

After the lamination was completed, a house-made PSS-LC material mixture which is a part of Smectic liquid crystal mixture (refer to US published patent application: 2004/0196428) was filled with the pressure difference method. After the liquid crystal material was filled in the panel, the filling hole was tipped-off by using UV curable resin. The obtained liquid crystal molecular alignment in this “round” shaped pillar spacer made of acrylic resin panel was not clean and showed many line shaped defects

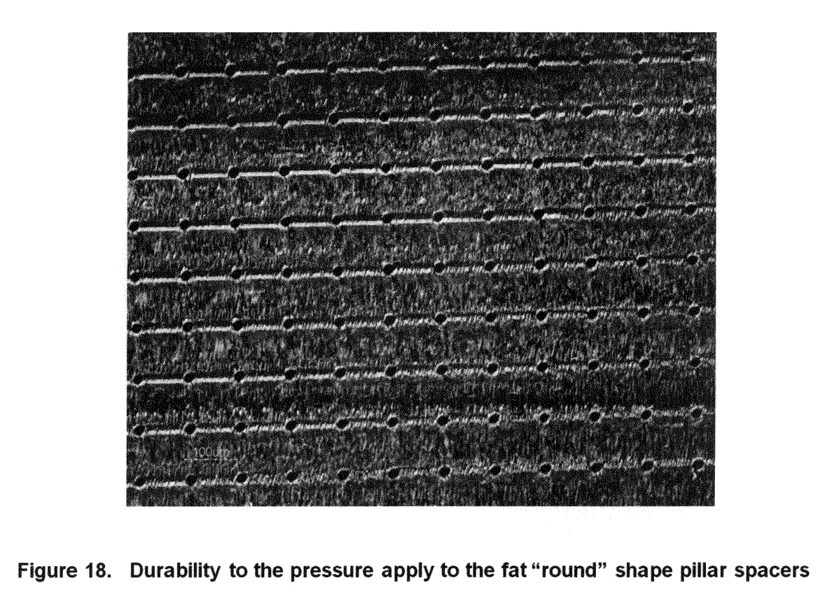

Using panels prepared by above, mechanical strength was measured using commercially available pressuring machine: MX-500N-E made by IMADA Co., Ltd. Japan. Using φ 5 mm pressure cylinder tip, several amount of pressures were applied. FIG. 18 shows the result of the PSS-LC molecular alignment after the application of pressure. As shown in the FIG. 18, it was confirmed that the equivalent pressure of 5 kg/φ 2 mm provided significant change in the molecular alignment. The size of the specific “round” shaped pillar spacer is 1,254 μm² each, therefore, this size of pillar spacer does not reduce aperture ratio significantly.

(Impact of the Present Invention)

The present invention provides stable enough durability against mechanical stress to a Smectic based liquid crystal display without disturbing the Smectic liquid crystal molecular alignment. Moreover, the formed specific shaped pillar spacers may not reduce aperture ratio at a TFT-LCD. The place formed the spacer is behind black matrix, storage capacitor, and any metal area, therefore these area are originally block incident light. As long as the spacers are formed behind these light blocking area, aperture ration of the panel does not have any influence in terms of aperture ratio.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal display panel embedded with pillar type of spacers comprising a photo reactive material,
wherein the mechanical durability of the pillar type of spacers has at least 15.9 MPs of mechanical strength to the external pressing force.

2. An active matrix type of liquid crystal display panel embedded with pillar type of spacers comprising a photo reactive material,
wherein the pillar spacers are formed only behind light blocking portion of the active matrix panel and the pillar spacers do not reduce aperture ratio of the active matrix liquid crystal panel.

3. A liquid crystal display panel embedded with pillar type of spacers comprising a photo reactive material, in order to achieve required the mechanical durability of the pillar type of spacers according to claim 1,
wherein the total area of the pillar spacers has at least 22% of the area required to be supported by the pillar spacers.

4. An active matrix type of liquid crystal display panel according to claim 2, which comprises thin film type of transistors.

5. A liquid crystal display panel embedded with pillar type of spacers comprising a photo reactive material, in order to achieve required the mechanical durability of the pillar type of spacers according to claim 1,
wherein the shape of the pillar spacer has “cross” shape, and the density of the “cross” shape spacer is more than 24% of the area required to be supported by the pillar spacers.

6. A liquid crystal display panel embedded with pillar type of spacers comprising a photo reactive material, in order to achieve required the mechanical durability of the pillar-type of spacers according to claim 1,
wherein the shape of the pillar spacer has “L” shape, or “L-cross” shape, and the density of the spacer is at least 22% of the area required to be supported by the pillar spacers.

7. A liquid crystal display panel embedded with pillar type of spacers comprising a photo reactive material, in order to achieve required the mechanical durability of the pillar type of spacers according to claim 1,
wherein the shape of the pillar spacer has “T” shape, and the density of the “cross” shape spacer is at least 22% of the area required to be supported by the pillar spacers.
